(19) United States
(12) Patent Application Publication
(10) Pub. No.: US 2009/0192255 A1
(43) Pub. Date: Jul. 30, 2009

(54) SILICA-POLYMERIC RESIN COMPOSITE AND METHOD FOR MANUFACTURING THE SAME

(75) Inventors: Yu-Ming Lin, Jhubei City (TW); Ching-Chang Hsieh, Tainan City (TW); Lik-Hang Chau, Tainan City (TW)

Correspondence Address: PAI PATENT & TRADEMARK LAW FIRM, 1001 FOURTH AVENUE, SUITE 3200, SEATTLE, WA, 98154, US

(73) Assignee: INDUSTRIAL TECHNOLOGY RESEARCH INSTITUTE, Hsinchu County (TW)

(21) Appl. No.: 12/191,248

(22) Filed: Aug. 13, 2008

(30) Foreign Application Priority Data
Jan. 28, 2008 (TW) 97103045
Jun. 17, 2008 (TW) 97122512

(51) Int. Cl. C08K 3/34

(52) U.S. Cl. 524/493; 977/773

(57) ABSTRACT

The disclosed is a silica-polymeric resin composite of blending the silicon dioxide nanoparticles in thermoplastic polymer and method for manufacturing the same, thereby improving its scratch-resistance. A thermoplastic polymer is dissolved in solvent to form a thermoplastic polymer solution. The polymer solution is evenly mixed with a silicon dioxide sol, and the solvent is then removed to complete the silica-polymeric resin composite. In the silica-polymeric resin composite, the silicon dioxide nanoparticles and the thermoplastic polymer have no chemical bonding therebetween, and the silicon dioxide nanoparticles are evenly dispersed in the thermoplastic polymer.

### CROSS REFERENCE TO RELATED APPLICATIONS

This Application claims priority of Taiwan Patent Application No. 097122512 filed on Jun. 17, 2008, which is a Continuation-In-Part of Taiwan Patent Application No. 097103045 filed on Jan. 28, 2008, the entirety of which is incorporated by reference herein.

### BACKGROUND OF THE INVENTION

1. Field of the Invention

The invention relates to a composite material, and in particular to blending silicon dioxide nanoparticles in thermoplastic polymer.

2. Description of the Related Art

Thermoplastic polymer has excellent machinability and optical properties, however, require enhancements for stability and mechanical properties. Those skilled in the art directly blend the silicon dioxide powder into the thermoplastic polymer by mechanical agitation, thereby improving the hardness and abrasion resistance of the thermoplastic polymer. The method is defective because the silicon dioxide powder is easily aggregated to form pieces with different sizes, thus making the polymer to have inconsistent mechanical properties.

Alternatively, those skilled in the art utilize alkoxy silane such as tetraethoxy silane, to serve as a crosslinking agent to crosslink the functional groups of the polymer. Similarly, the crosslinking agent may copolymerize with the monomer, such that the backbone of the polymer has —O—Si—O— bonding (e.g. commercially available silicon rubber). The described methods both form chemical bonding between the silicon dioxide and the polymer. The disadvantages of these methods are that the polymer properties, such as transparency and hardness, are degraded by modification. For example, if a higher abrasion resistance of the polymer is demanded, directly adding the crosslinking agent into a modified polymer is not allowable. Another polymer with a higher crosslinking agent ratio should be newly produced to satisfy the higher abrasion resistance requirement.

Accordingly, a novel method to evenly blend silicon dioxide into polymer is called for.

### SUMMARY OF THE INVENTION

The invention provides a silica-polymeric resin composite, comprising a thermoplastic polymer and silicon dioxide nanoparticles evenly dispersed in the thermoplastic polymer. The silicon dioxide nanoparticles are composed of a silicon dioxide precursor and an end-capping agent, the silicon dioxide nanoparticles and the thermoplastic polymer have no chemical bonding therebetween, the silicon dioxide nanoparticles have a diameter of 5 nm to 100 nm, and the crystal structure of silicon dioxide nanoparticles are amorphous.

The invention also provides a method for forming a silica-polymeric resin composite, comprising dissolving a thermoplastic polymer in a solvent to form a thermoplastic polymer solution, providing a silicon dioxide sol, evenly mixing the thermoplastic polymer solution and the silicon dioxide sol, and removing the solvent to form a silica-polymeric resin composite.

A detailed description is given in the following embodiments.

### DETAILED DESCRIPTION OF THE INVENTION

The invention also provides a method for forming a silica-polymeric resin composite. First, a thermoplastic polymer is dissolved in solvent to form a polymer solution. In one embodiment, the thermoplastic polymer is poly(methylacrylate). In other embodiments, the thermoplastic polymer can be ethylene vinyl acetate, polybutadiene, polyethylene terephthalate, polyethylene, polypropylene, polybutylene, poly(vinyl chloride), polystyrene, polyamide, or blends thereof. The thermoplastic polymer has a molecular weight of about 60,000 to 110,000. The suitable solvent may totally dissolve the thermoplastic polymer, such as toluene, acetone, or co-solvent thereof.

The sequence of preparing a silicon dioxide sol and the polymer solution is not limited. The preparation of the silicon dioxide sol can be before, after, or simultaneously during the preparation of the polymer solution, as necessary. In one embodiment, the silicon dioxide sol is prepared as below. The silicon dioxide precursor is dissolved in an acid solution and heated for reaction. In this step, the silicon dioxide precursor will grow to form silicon dioxide nanoparticles. The size of the silicon dioxide nanoparticles is determined by factors such as the silicon dioxide precursor type, pH value of the acid solution, reaction time, and reaction temperature. Note that a longer reaction time and/or higher reaction temperature causes a higher growth speed of the silicon dioxide nanoparticles. In extreme condition, the silicon dioxide nanoparticles crosslink to each other, such that the reaction solution becomes turbid. In one embodiment, the silicon dioxide precursor is tetraethoxy silane. In other embodiments, the silicon dioxide precursor can be tetramethoxy silane, tetrapropoxy silane, tetrabutoxy silane, silicon tetrachloride, or silicon tetraacetate. The acid solution comes from a general acid source, such as acetic acid solution, hydrochloro acid solution, nitric acid solution, and the likes. The reaction time is about 1 to 48 hours, and the reaction temperature is about 60° C. to 96° C.

Subsequently, an end-capping agent is added to the described reaction solution and reacted at the same temperature for a period of time. The end-capping agent is used to reduce the terminal activity of the growing silicon dioxide nanoparticles, such that the nanoparticles stop growing and stabilize at a suitable size. The suitable end-capping agent includes 3-methacryloxypropyltrimethoxysilane, 3-glycidoxypropyltrimethoxysilane, trimethoxy(vinyl)silane, or (3-aminopropyl)trimethoxysilane, etc. In one embodiment, the end-capping agent and the silicon dioxide precursor have a weight ratio of 0.16:1 to 0.25:1.

Finally, the described solution is cooled down to room temperature to obtain the so-called silicon dioxide sol. The sol contains silicon dioxide nanoparticles having a size of about 5 nm to 100 nm. In one embodiment, the silicon dioxide nanoparticles in the silicon dioxide sol have a weight fraction in range of 0.01 to 10.

After preparing the silicon dioxide sol, the sol and the polymer solution are evenly mixed. In one embodiment, the silicon dioxide nanoparticles and the thermoplastic polymer have a weight ratio of 1:100 to 40:100. The mixing method can be by ultrasonic vibration, mechanical agitation, or combinations thereof. After even mixing, the solvent of the mixture was removed to complete the silica-polymeric resin composite. The step of removing the solvent is processed at a temperature of 20° C. to 60° C. and a pressure of 1 torr to 100 torr. After removal of the solvent, the silica-polymeric resin composite is further dried by heating to avoid solvent residue. The thermal drying is processed at a temperature of 90° C. to 130° C. The silica-polymeric resin composite made of the described method has a pencil surface hardness of 3H to 5H and a transparency of 80% to 93%. In addition, the silicon dioxide nanoparticles are evenly dispersed in the thermoplastic polymer, and the crystal structure of silicon dioxide nanoparticles are amorphous.

The silica-polymeric resin composite has several advantages. First, the silicon dioxide sol and the polymer solution are mixed in room temperature, thereby simplifying the process and decreasing costs. Second, the terminals of the silicon dioxide nanoparticles are deactivated by the end-capping agent, such that the silicon dioxide nanoparticles will not crosslink to each other and aggregate to destroy the composite physical properties. Next, the silicon dioxide nanoparticles and the thermoplastic polymer have no chemical bonding therebetween, the nanoparticles are evenly dispersed in the thermoplastic polymer, and their ratio could be optionally tuned as necessary. Third, commercially available thermoplastic polymer is directly utilized as a raw material, and can be blended with the silicon dioxide nanoparticles to form the silica-polymeric resin composite. The composite can be further pelletized for applications in industries such as the furniture industry, the optoelectronic industry, the textile industry, or the automotive industry.

The following description is of the best-contemplated mode of carrying out the invention. This description is made for the purpose of illustrating the general principles of the invention and should not be taken in a limiting sense. The scope of the invention is best determined by reference to the appended claims.

### EXAMPLES AND COMPARATIVE EXAMPLES

### Example 1

165.7 mL of acetic acid (0.04N, pH=1.42) and 4,340 mL of propanol were mixed to form an acid solution. The acid solution was added 347.2 g of tetraethoxy silane (commercially available from Showa Chemical Co. Ltd., Japan), heated to 80° C., and reacted at 80° C. for 90 minutes. Subsequently, the acid solution was added 55.6 g to 86.8 g of 3-methacryloxypropyl trimethoxy silane as an end capping agent, and reacted at 80° C. for 24 hours. At last, the resulting solution was cooled to room temperature to obtain a silicon dioxide sol, wherein 10 g of silicon dioxide nanoparticles were evenly dispersed in 4,674 g of solvent. The silicon dioxide nanoparticles size, 5 nm to 100 nm, was determined by a dynamic light scattering instrument (HORIBA LB-550).

1,000 g of poly(methylacrylate) (CM-211, commercially available from Chi-Mei Co. Ltd., Taiwan) was dissolved in 2,070 g of solvent to form a polymer solution. The polymer solution and the silicon dioxide sol were mechanically agitated, and then evacuated under 5 torr at 35° C. to remove 3,454 g of solvent. The resulting product was thermally dried at 110° C. for 24 hours to obtain 1,100 g of silica-polymeric resin composite. The silicon dioxide nanoparticles and the polymer had a weight ratio of 10:100. The silica-polymeric resin composite was transparent, similar to the commercially available poly(methylacrylate) in appearance. By injection molding, a sample specimen (9 cm*5 cm*3 mm) was made from the silica-polymeric resin composite. The transparency of the sample sheet, greater than 81%, was measured by a UV-VIS analyzer (Lambda, commercial available from Perkin Elmer). The surface hardness of the sample, greater than 4H, was measured by a pencil hardness tester (Lambda, commercial available from Jiinliang, Co., Taiwan).

### Comparative Example 1

1,000 g of poly(methylacrylate) (CM-211, commercially available from Chi-Mei Co. Ltd., Taiwan) was directly blended with 100 g of silicon dioxide nanoparticles in powder form. By injection molding, a sample sheet (9 cm*5 cm*3 mm) was made from the mixture. The transparency of the sample sheet, less than 20%, was measured by a UV-VIS analyzer (Lambda, commercial available from Perkin Elmer). Compared to the sample made from pure poly(methylacrylate) with transparency of 85% to 93%, the method of direct blending significantly reduced the sample sheet transparency by a wide margin. The reduced transparency was caused by the aggregation of the directly blending with silicon dioxide powder, thereby decreasing the dispersion of the silicon dioxide nanoparticles in the resin matrix.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A silica-polymeric resin composite, comprising:
a thermoplastic polymer; and
silicon dioxide nanoparticles evenly dispersed in the thermoplastic polymer;
wherein the silicon dioxide nanoparticles are composed of a silicon dioxide precursor and an end-capping agent;
the silicon dioxide nanoparticles and the thermoplastic polymer have no chemical bonding therebetween;
the silicon dioxide nanoparticles have a diameter of 5 nm to 100 nm; and
the crystal structure of silicon dioxide nanoparticles are amorphous.

2. The silica-polymeric resin composite as claimed in claim 1, wherein the thermoplastic polymer comprises poly(methylacrylate), ethylene vinyl acetate, polybutadiene, polyethylene terephthalate, polyethylene, polypropylene, polybutylene, poly(vinyl chloride), polystyrene, polyamide, or blends thereof.

3. The silica-polymeric resin composite as claimed in claim 1, wherein the thermoplastic polymer has a molecular weight of 60,000 to 110,000.

4. The silica-polymeric resin composite as claimed in claim 1, wherein the silicon dioxide nanoparticles and the thermoplastic polymer have a weight ratio of 1:100 to 40:100.

5. The silica-polymeric resin composite as claimed in claim 1, wherein the silicon dioxide precursor comprises tetramethoxy silane, tetraethoxy silane, tetrapropoxy silane, tetrabutoxy silane, silicon tetrachloride, or silicon tetraacetate.

6. The silica-polymeric resin composite as claimed in claim 1, wherein the end-capping agent comprises 3-methacryloxypropyl trimethoxy silane, 3-glycidoxypropyltrimethoxysilane, trimethoxy(vinyl)silane, or (3-aminopropyl)trimethoxysilane.

7. The silica-polymeric resin composite as claimed in claim 1, wherein the end-capping agent and the silicon dioxide precursor have a weight ratio of 0.16:1 to 0.25:1.

8. The silica-polymeric resin composite as claimed in claim 1 has a pencil surface hardness of 3H to 5H.

9. The silica-polymeric resin composite as claimed in claim 1 has a transparency of 80% to 93%.

10. A method for forming a silica-polymeric resin composite, comprising:
dissolving a thermoplastic polymer in a solvent to form a thermoplastic polymer solution;
providing a transparent and well-dispersed silicon dioxide sol;
evenly mixing the thermoplastic polymer solution and the silicon dioxide sol; and
removing the solvent to form a silica-polymeric resin composite.

11. The method as claimed in claim 9, wherein the thermoplastic polymer comprises poly(methyl acrylate), ethylene vinyl acetate, polybutadiene, polyethylene terephthalate, polyethylene, polypropylene, polybutylene, poly(vinyl chloride), polystyrene, polyamide, or blends thereof.

12. The method as claimed in claim 10, wherein the solvent comprises toluene, acetone, or co-solvent thereof.

13. The method as claimed in claim 10, wherein the step of providing the silicon dioxide sol comprises:
i) dissolving a silicon dioxide precursor in an acid solution and heating the acid solution to 60-96° C.;
ii) adding an end-capping agent to the solution of step i) to further react at 60-96° C.; and
iii) cooling the solution of step ii) to room temperature to form the silicon dioxide sol;
wherein the silicon dioxide sol comprises silicon dioxide nanoparticles.

14. The method as claimed in claim 13, wherein the silicon dioxide nanoparticles in the silicon dioxide sol have a weight fraction of 0.01 to 10.

15. The method as claimed in claim 13, wherein the silicon dioxide nanoparticles and the thermoplastic polymer have a weight ratio of 1:100 to 40:100.

16. The method as claimed in claim 13, wherein the silicon dioxide precursor comprises tetramethoxy silane, tetraethoxy silane, tetrapropoxy silane, tetrabutoxy silane, silicon tetrachloride, or silicon tetraacetate.

17. The method as claimed in claim 13, wherein the end capping agent comprises 3-methacryloxypropyl trimethoxy silane, 3-glycidoxypropyltrimethoxysilane, trimethoxy(vinyl)silane, or (3-Aminopropyl)trimethoxysilane.

18. The method as claimed in claim 13, wherein the end-capping agent and the silicon dioxide precursor have a weight ratio of 0.16:1 to 0.25:1.

19. The method as claimed in claim 10, wherein the step of evenly mixing the thermoplastic polymer solution and the silicon dioxide sol comprises ultrasonic vibration, mechanical agitation, or combinations thereof.

20. The method as claimed in claim 10, wherein the step of removing the solvent is processed under a pressure of 1 torr to 100 torr and a temperature of 20° C. to 60° C.

21. The method as claimed in claim 10, further comprising a step of thermal drying, and the thermal drying has a temperature of 90° C. to 130° C.
